(19) United States
(12) Patent Application Publication
(10) Pub. No.: US 2012/0152668 A1
(43) Pub. Date: Jun. 21, 2012

(54) BRAKE PLATE

(75) Inventors: Diego A. Santamaria Razo, Barge (IT); Luca Martinotto, Barge (IT); Daniele Donzelli, Barge (IT)

(73) Assignee: ITT MANUFACTURING ENTERPRISES, INC., Wilmington, DE (US)

(21) Appl. No.: 13/326,142

(22) Filed: Dec. 14, 2011

Related U.S. Application Data
(63) Continuation-in-part of application No. PCT/EP2010/058380, filed on Jun. 15, 2010.

(30) Foreign Application Priority Data
Jun. 15, 2009 (IT) TO2009A000457

(51) Int. Cl. F16D 65/097; B29C 65/44; F16D 69/02

(52) U.S. Cl. 188/251 R; 264/642

(57) ABSTRACT

A plate for a braking system of a motor vehicle includes a back plate, a friction layer and a particle damping device.

### BACKGROUND

1. Technical Field

The present disclosure relates to a brake pad for a breaking system, preferably for a motor vehicle.

2. Description of the Related Art

A brake pad cooperates with a brake disc to dissipate kinetic energy by friction and decrease the angular speed of the disc. In particular the disc can be rigidly connected to the wheel of a car or a motorcycle so that during braking the vehicle decelerates. In principle a brake pad consists at least of a rigid back plate or carrier and a layer of friction material.

Friction between the brake pad and the brake disc generates heat and noise. In particular, the latter effect is undesirable.

It is known from WO-A-0014425 to use a particle damping device in a braking system to avoid undesired noise. The above application relates to breaking pads made of a thermo-structural material, i.e. carbon-carbon composite. In particular, the friction layer is made of a carbon-carbon composite so that this layer has also an independent structural function and can be manufactured in parallel to the back plate and then assembled. In particular, the above mentioned document discloses that the cavity housing for the particles is defined by the friction layer. However, some brake pads comprise a friction layer that is deposited on the back plate and then sintered.

A brake pad provided with a non-structural friction layer provides some open issues relating to the cost efficiency of the manufacturing method because of the fact that the friction layer is substantially inconsistent, i.e. is a mix of organic & inorganic powders and a binder, before the heat and pressure treatment.

### BRIEF SUMMARY

Some embodiments of the present disclosure provide a brake pad provided with a particle damping device and a cost efficient manufacturing method for a sintered friction layer.

One embodiment of the present disclosure is a brake pad according to claim 1.

### BRIEF DESCRIPTION OF THE SEVERAL VIEWS OF THE DRAWINGS

The present disclosure will now be described in a non-limiting preferred embodiment with reference to the accompanying drawings, in which:

FIG. 1 is a transversal section of a perspective view of a brake plate according to the present disclosure; and

FIG. 2 is a graph comparing the frequency response function of a traditional brake plate (dashed) and a brake plate according to the present disclosure (solid).

### DETAILED DESCRIPTION

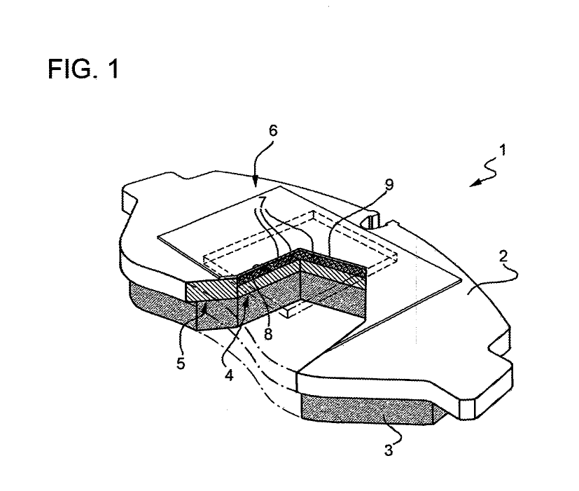

In FIG. 1 reference number 1 indicates as a whole a brake plate for a braking system of a motor vehicle, in particular a car or a motorbike.

Brake plate 1 comprises a back plate 2 made preferably of steel or cast iron, a friction layer 3 preferably sintered on back plate 2, and a particle damping device 4. Back plate 2 has a first surface 5 defining an interface with friction layer 3 and a second surface 6 opposite to first surface 5 and contacting known support elements of the braking system, such as pistons and calipers. Friction layer 3 is preferably a composite material constituted by a powder and matrix that needs to be heat treated, e.g. hot pressed or sintered, on back plate 2. Such a powder is a mix of different compounds, i.e. a mix of friction compounds, a mix of lubricant compounds, a mix of inert compounds, and a mix of metals. Therefore, the powder is a mix of organic and inorganic compounds. The matrix is preferably a polymeric compound, more preferably a phenolic resin.

Particle damping device 4 comprises a granular material having a plurality of particles 7 housed in at least a cavity 8 preferably defined by brake plate 1 and having preferably a rectangular/squared perimeter. Particles 7 are free to move in cavity 8, which means free to translate in three orthogonal direction and free to rotate about three mutually orthogonal axes, i.e. they have 6 degrees of freedom (DOF).

Particles 7 can be of any shape, preferably spherical and their characteristic dimension, in particular diameter, ranges from a fraction of a millimeter, for example from 0.1 mm, to 10 mm depending on the dimension of the brake plate. According to the present disclosure, good empirical results were obtained with dry particle damping, i.e. particles are not combined with a fluid. However, particles combined with a gel may be of advantage if during certain manufacturing handling the cavity is open.

According to a preferred design practice, particles 7 are dimensioned to occupy no more than 90% in volume of cavity 8 so that they are free to move in the cavity itself Furthermore, the material of particles 7 can be chosen upon the intended application, for example it is possible to use steel spheres. Alternative to the later described preferred solution to have the particles 7 in the cavity during sintering, particles can be filled into the cavity after the sintering process of the friction layer is completed, then only normal operation temperatures have to be considered for selection of the particle material.

Advantageously, the position of cavity 8 can be identified according to the following steps:

performing a free-free analysis of back plate 2 without damping device 4 to obtain a frequency response function;

identifying at least the highest peak of amplitude and the relative vibration mode;

locating cavity/cavities 8 far from nodes and close to the points having the highest vibration amplitude of the selected vibration mode/modes. Preferably, the point/points of highest vibration amplitude shall fall within the perimeter of cavity/cavities 8.

The brake plate 1 comprises a plurality of fixing portions for connection with known supporting elements to be actuated against the brake disk of the braking system. Therefore, it might happen that the points having the highest vibration amplitude lie close to such fixing portions (not shown), which are unsuitable for locating a cavity 8. In this case it is possible to locate cavity 8 close to such points without any interference with the fixing portions of brake pad 1.

According to a preferred embodiment of the present disclosure, cavity 8 is a recess of surface 6 and can be closed by a shim 9 normally used on a brake plate 1 facing to the actuation elements.

According to one embodiment, particles 7 are assembled in cavity 8 as follows. Particles 7 are packed in a package housed in cavity 8. The package is made of a material that burns/melts after cavity 8 is closed, e.g. of cellulose, at a temperature that preserves the functionality of all the other components of brake plate 1, i.e. the burning temperature of cellulose is far lower than the sintering temperature of the friction layer 3 and/or of annealing temperature of steel of the support plate 2 and/or particles 7. According to a preferred embodiment of the present disclosure, burning/melting temperature of the package is below the temperature at which friction layer 3 is sintered on support plate 2.

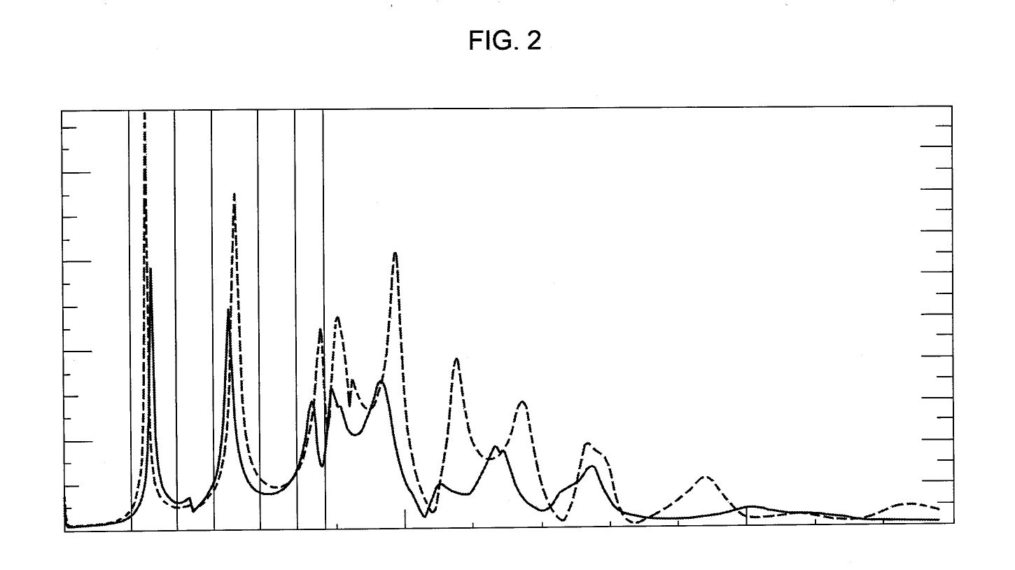

FIG. 2 shows a comparison of a brake plate 1 with a particle damping device 4 according to the present disclosure and a back plate having a conventional antinoise shim.

Spectra are similar which means that the dimension of the cavity is small compared to the overall mass of the brake plate. In particular the little shift at low frequency is the result of the weight difference.

A good damping of high frequencies, i.e. the noisy frequencies, is evident.

A brake plate according to the present disclosure has the following advantages.

Noise attenuation is up to 80% with almost no impact on the manufacturing process and manufacturing costs. In particular, it is possible to manufacture cavity 8 before the heat treatment of friction layer 3 and afterwards close the same with a plate equivalent to shim 9 that is normally used to assemble brake plate to supporting elements. Therefore, the interface of the braking system is not required to be adapted to the improved brake plate.

Furthermore, cavity 8 is defined by the back plate so that it is possible to deposit any kind of friction material with no impact on the manufacturing steps relating to the friction plate. Therefore, the braking pad according to the present disclosure is suitable for any friction material, including sintering ones.

Furthermore, the damping is temperature independent because energy is dissipated in collisions and temperature has little influence on this kind of process.

When the burning/melting temperature of the package of the granular material is lower than a sintering temperature of friction layer 3, a single manufacturing phase is used without any impact on the manufacturing process.

It is finally apparent that modifications and variants can be made to brake plate 1 disclosed and illustrated herein without departing from the scope of protection of the present disclosure.

In particular, depending on the mix of compounds constituting the friction layer, the latter can be fixed to the back plate by hot pressing instead of sintering.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A brake plate for a braking system of a motor vehicle, comprising:
a back plate;
a friction layer constituted by a braking friction material sintered on and supported by said back plate; and
a particle damping device defining a cavity, said cavity being defined by said back plate on a first surface that is opposite to a second surface facing said friction layer.

2. A brake plate as claimed in claim 1, comprising a shim that closes said cavity.

3. A brake plate according to claim 1, wherein said particle damping device comprises a granular material free to move in at least said cavity.

4. A brake plate as claimed in claim 3, wherein said granular material has a volume up to 90% of said cavity.

5. A brake plate as claimed in claim 1, wherein said particle damping device is positioned at least close to points of maximum vibration amplitude of a vibration mode of said back plate.

6. A brake plate as claimed in claim 1, wherein said points of maximum vibration amplitude lie within a perimeter of said cavity.

7. A brake plate as claimed in claim 1, wherein said friction layer comprises a mix of powders having inorganic and organic compounds.

8. A method of manufacturing a brake plate, the method comprising:
forming a back plate;
forming a friction layer constituted by a braking friction material sintered on and supported by said back plate; and
forming a particle damping device defining a cavity, said cavity being defined by said back plate on a first surface that is opposite to a second surface facing said friction layer.

9. A method as claimed in claim 8, wherein forming the particle damping device includes:
housing in said cavity a package containing granular material;
closing said cavity; and
heating said brake plate at a temperature that is higher than a burning/melting temperature of a material of said package.

10. A method as claimed in claim 9, wherein said burning/melting temperature is lower than a sintering/hot pressing temperature of said friction layer.
